(19) United States
(12) Patent Application Publication
(10) Pub. No.: US 2009/0127040 A1
(43) Pub. Date: May 21, 2009

(54) Torsional Vibration Damper Arrangement

(75) Inventors: Thomas Busold, Fulda (DE); Cora Carlson, Dittelbrunn (DE); Thomas Dogel, Bad Kissingen (DE); Andreas Orlamunder, Schonungen (DE); Thomas Schade, Niederwerrn (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/270,269

(22) Filed: Nov. 13, 2008

(30) Foreign Application Priority Data
Nov. 15, 2007 (DE) 10 2007 054 568.3
Jun. 25, 2008 (DE) 10 2008 002 632.8

(51) Int. Cl. F16F 9/12

(52) U.S. Cl. 188/269

(57) ABSTRACT

A torsional vibration damper with a primary side and a secondary side, wherein rotation of the primary side relative to the secondary side causes displacement of hydraulic fluid from at least one displacement chamber and compression of pneumatic fluid in at least one compensating chamber. A first displacement chamber assembly includes a pair of axially opposed end walls bounding each displacement chamber in both axial directions and a circumferential wall bounding it in one radial direction, and a second displacement chamber assembly bounds it in the other radial direction. A sealing arrangement is provided between the end walls and the second displacement chamber assembly to produce an essentially fluid-tight closure of the at least one displacement chamber.

### BACKGROUND OF THE INVENTION

1. Field of the Invention

The present invention pertains to a torsional vibration damper arrangement, a primary side and a secondary side, which is able to rotate around an axis of rotation relative to the primary side against the action of a damper fluid arrangement.

2. Description of the Related Art

The damper fluid arrangement includes first damper fluid of lower compressibility (typically a hydraulic fluid) in at least one displacement chamber and a second damper fluid of higher compressibility (typically a pneumatic fluid) in at least one compensating chamber. Upon a decrease in the volume of at least one displacement chamber caused by the rotation of the primary side relative to the secondary side and thus upon displacement of fluid from this displacement chamber, the second damper fluid is compressed in at least one compensating chamber.

In a torsional vibration damper arrangement of this type, it must be ensured that the various damper fluids are prevented from escaping from the outlets of the volume areas containing them. That is, leakage must be avoided. It must also be ensured that the two damper fluids do not mix with each other; that is, the one fluid must be prevented from entering the closed volume areas provided for the other damper fluid.

### SUMMARY OF THE INVENTION

It is therefore the goal of the present invention to design a torsional vibration damper arrangement of the type described above in such a way that problems with the escape of fluid or the mixing of fluids can be avoided.

According to the invention, the minimum of one displacement chamber is bounded by a first displacement chamber assembly with end walls which form the axial boundaries of the minimum of one displacement chamber in both axial directions and with a circumferential wall which forms the boundary of the displacement chamber in one radial direction, and by a second displacement chamber assembly, which is able to rotate around the axis of rotation relative to the first displacement chamber assembly and which forms the boundary of the minimum of one displacement chamber in the other radial direction.

First sealing arrangements acting between the two end walls and the second displacement chamber assembly are provided to produce an essentially fluid-tight closure of the minimum of one displacement chamber

Alternatively or additionally, the first displacement chamber assembly includes a first circumferential boundary projection, which is assigned to the minimum of one displacement chamber, extends radially toward the second displacement chamber assembly, and forms the boundary of the minimum of one displacement chamber in a first circumferential direction. The second displacement chamber assembly includes a second circumferential boundary projection, which is assigned to the minimum of one displacement chamber, extends toward the circumferential wall of the first displacement chamber assembly, and forms the boundary of the minimum of one displacement chamber in the second circumferential direction Second sealing arrangements acting between these projections and the other displacement chamber assembly are provided on the circumferential boundary projections to produce an essentially fluid-tight closure of the minimum of one displacement chamber.

Alternatively or additionally, the minimum of one compensating chamber is formed in a compensating cylinder, in which a separating piston, which separates the first damper fluid from the second damper fluid, is free to move back and forth, where a third sealing arrangement to produce an essentially fluid-tight closure of the minimum of one compensating chamber is provided between the separating piston and the compensating cylinder.

In the inventive torsional vibration damper arrangement, therefore, appropriate sealing arrangements are provided in various areas which are critical with respect to the escape of fluid or to the mixing of the fluids.

Because very high pressures of up to 70 bars or more can be present in the displacement chambers containing the first damper fluid, especially when high torques are being transmitted, at least one first sealing arrangement can be designed in two stages with a first sealing area, which acts essentially between an axial side of an end wall and an axial side of the second displacement chamber assembly, and with a second sealing area, which acts essentially between a circumferential surface of the end wall and a circumferential surface of the second displacement chamber assembly lying radially opposite the circumferential surface of the end wall.

It is possible, for example, for the first sealing area to include a first ring-like sealing element, which is supported by its first support surface on the second displacement chamber assembly, and a second sealing element, which is supported by its first support surface on the end wall by way of a prestressing element, where the second support surfaces of the two sealing elements rest against each other. At least one of the first support surfaces can be essentially perpendicular to the axis of rotation. The second support surfaces can be essentially conical with respect to the axis of rotation.

To avoid excessive friction in the area of the first sealing area as effectively as possible, it is proposed that the second sealing element not be in, or not be able to enter into, contact with the second displacement chamber assembly.

The prestressing element can be, for example, a wave spring or a disk spring.

So that the high pressure prevailing in a displacement chamber can also be used to increase the effectiveness of the fluid seal, at least one connecting recess can be formed in the end wall to form a fluid connection between at least one displacement chamber and a side of the second sealing element facing away from the second displacement chamber assembly. In this way, the second sealing element can be pressed more strongly against the first sealing element, which will then also be pressed more strongly against the second displacement chamber assembly.

The second sealing area can be formed by a groove, open in the radial direction, in the end wall or in the second displacement chamber assembly. A ring-like sealing element, which rests with a sealing action against the other component, is installed in this groove.

The ring-like sealing element can be provided with a prestressing arrangement to load the element against the other component in question. This prestressing arrangement can include at least one prestressing element with spring-like elasticity. Alternatively or in addition, however, it can include a pressurized fluid connection, via which the groove-like recess is connected to at least one displacement chamber. Here, too, the very high fluid pressure prevailing in at least one displacement chamber can be used to improve the effectiveness of the seal. The two sealing arrangements can be essentially identical in design.

In an alternative embodiment, the ring-like sealing element can be designed as an open ring with an interrupted area in its circumference.

To achieve the most effective possible seal in the area of the circumferential boundary projections as well, at least one second sealing arrangement may include a radially and axially prestressed sealing element, which is inserted into a gap-like recess in a circumferential boundary projection, this gap being open in both the radial and axial directions.

This can also be achieved, for example, by designing the sealing element like a frame, and arranging at least one prestressing element, which pestresses the sealing element radially and/or axially, in the frame-like sealing element.

The internal volume area of the frame-like sealing element can be covered on both sides by cover elements, and a fluid inlet can be provided in at least one of these cover elements. Here, too, fluid can thus arrive in the internal volume area from at least one displacement chamber and thus preload the frame-like sealing element in the outward direction.

At least one third sealing arrangement can be designed to include a ring-like sealing element, which is inserted into a circumferential recess in a separating piston, and, in association with it, a prestressing arrangement, by means of which the sealing element is preloaded radially outward against an inside circumferential surface of the compensating cylinder.

The fluid pressure of the first damper fluid in the area of the minimum of one third sealing arrangement can also be used to improve the seal, by connecting the circumferential recess to a volume area containing first damper fluid by at least one connecting opening.

It is possible, for example, for the ring-like sealing element to be designed as an open ring with an interrupted area in its circumference.

Even when the separating position is located in one of its end positions, i.e., even when, for example, the volume of a compensating chamber is at its maximum or at its minimum, measures can still be taken to improve the effectiveness of the seal. In correlation with at least one of the end positions of the separating piston, the third sealing arrangement may include a sealing element, which is provided preferably on the compensating cylinder and which, when the separating piston is in its end position, produces a sealing action between the piston and the compensating cylinder.

The working characteristics of the inventive torsional vibration damper arrangement can also be improved by providing a holding recess, open to the compensating chamber, for the second damper fluid contained in the compensating chamber, this recess being located in the separating piston and/or in a closure element, which closes off the compensating chamber in the compensating cylinder. In this way, it is ensured that, even when the volume of the compensating chamber is at its minimum, that is, even when the separating piston has moved as far as possible in the outward direction, there will still be a certain residual volume present, in which essentially all of the second damper fluid is held. In this way, it is possible to prevent the second damper fluid from overheating under conditions of excessive compression.

It is also possible for the first displacement chamber assembly to be supported rotatably with respect to the second displacement chamber assembly by a bearing arrangement. The use of a rolling element bearing, preferably a needle bearing, has been found to be especially advantageous, because such bearings provide very precise mounting, and thus the possibility that abraded particles could arrive in the sealing arrangements can be almost completely excluded.

In an alternative embodiment which is comparatively simple and can be realized at low cost, the bearing arrangement can be a plain bearing.

It is also advantageous for the bearing arrangement to be designed as a loose bearing, which does not hinder relative axial movement between the two displacement chamber assemblies. The relative positioning in the axial direction can then be accomplished in the area of the two first sealing arrangements without interference from the bearing arrangement.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows a longitudinal cross section through a torsional vibration damper arrangement designed in the manner of a gas spring-dual mass flywheel;

FIG. 2 shows a cross-sectional view of the displacement chamber assemblies forming the boundaries of the displacement chambers;

FIG. 3 shows a longitudinal cross section through the two displacement chamber assemblies of FIG. 2 along line III-III of FIG. 2;

FIG. 4 shows an enlarged view of a compensating cylinder in isolation;

FIG. 5 shows a view, corresponding to FIG. 4, of an alternative embodiment;

FIG. 6 shows the upper part of a compensating cylinder;

FIG. 7 shows the lower part of a compensating cylinder, that is, the part closer to the displacement chambers;

FIG. 8 shows a detailed view of two displacement chamber assemblies and the seals between them;

FIG. 9 shows an enlarged view of the area inside the circle IX in FIG. 8;

FIG. 10 shows a sealing arrangement designed to be installed in the area of a circumferential boundary projection;

FIG. 11 shows an exploded view of the sealing arrangement of FIG. 10;

FIG. 12 shows a cross section of the sealing arrangement of FIG. 10;

FIG. 13 shows a partial cross-sectional view of the two displacement chamber assemblies with sealing arrangements provided in the circumferential boundary projections;

FIG. 14 shows a cross-sectional view of a circumferential boundary projection of a second displacement chamber assembly with a sealing arrangement provided therein;

FIG. 15 shows a cross section of a circumferential boundary projection of a first displacement chamber assembly with a sealing arrangement provided therein;

FIG. 16 in which parts (a)-(m) show various embodiments of sealing arrangements designed as piston seals; and

FIG. 17 in which parts (a)-(i) show various embodiments of sealing arrangements designed as rod seals.

### DETAILED DESCRIPTION OF THE PRESENTLY PREFERRED EMBODIMENTS

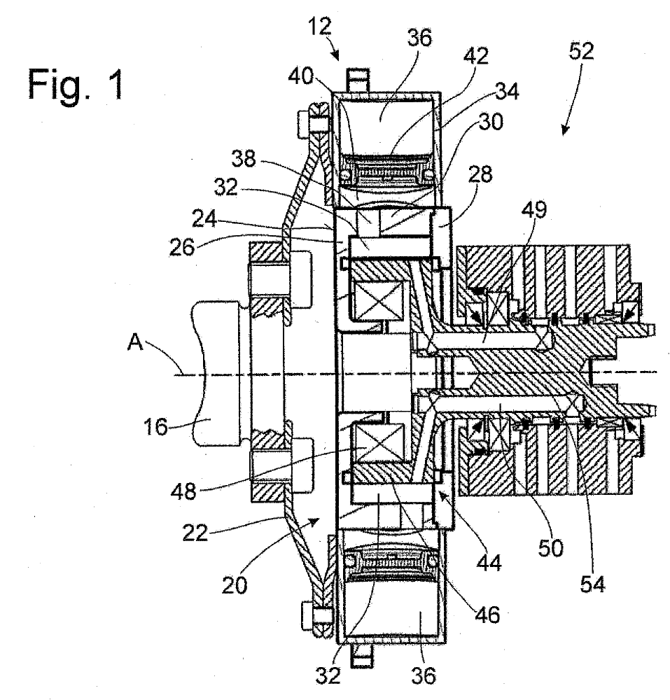

First, the general structure of a torsional vibration damper arrangement 12 designed according to the type of a gas spring-dual mass flywheel is described with reference to FIG. 1.

The torsional vibration damper arrangement 12 includes a primary side 20, which is or can be connected to a drive shaft 16 for rotation in common around the axis of rotation A by means of a flexplate arrangement 22 or the like. This primary side 20 includes a first displacement chamber assembly 24, the two end walls 26, 28 and the outside circumferential wall 30 of which form the axial and radial boundaries of a plurality of displacement chambers 32 arranged in a row around the circumference. Outside the outer circumferential wall 30, there is an arrangement, star-shaped with respect to the axis of rotation A, of compensating cylinders 34, in each of which a compensating chamber 36 is formed. The two different types of chambers can cooperate with each other in such a way that one compensating chamber 36 is assigned to each displacement chamber 32; that several compensating chambers 36 are assigned to one displacement chamber 32; or that one compensating chamber 36 works together with several displacement chambers 32. This cooperation takes place by way of a through-opening 38 in the outer circumferential wall 30 of each displacement chamber 32, 33, and by way of a connecting chamber 40, extending in the circumferential direction along the outer circumferential wall 28. A separating piston 42, which is able to move back and forth inside each compensating cylinder 34, separates the first damper fluid, which is present in the displacement chamber or chambers 32, is essentially incompressible, and can be, for example, an oil, from the second damper fluid contained in the assigned compensating chamber 36, this fluid being compressible, namely, a fluid such as air or some other gas.

A secondary side 44 of the torsional vibration damper arrangement 12 includes a second displacement chamber assembly 46, which is supported rotatably on the first displacement chamber assembly 24 by means of a bearing 48. The second displacement chamber assembly 46 forms the boundary of the displacement chambers 32 on the radially inner side and is guided in a fluid-tight manner with respect to the side walls 26, 28 by means of appropriate sealing arrangements.

To provide the boundaries of the displacement chambers 32, 33 in the circumferential direction, circumferential boundary projections 56, 58 are provided on the two displacement chamber assemblies 24, 46, each of these projections extending radially toward the other displacement chamber assembly, so that a circumferential boundary projection 56 of the primary-side first displacement chamber assembly 24 forms one of the boundaries of each displacement chamber 32, and a circumferential boundary projection 58 of the secondary-side second displacement chamber assembly 46 forms the other boundary of each chamber. Upon relative rotation of the primary side 20 versus the secondary side 44 in a first direction of relative rotation, the volume of the displacement chamber 32 located in the upper part of FIG. 1, for example, decreases, so that the first damper fluid is displaced out of this chamber into the assigned connecting chamber 40, and the second damper fluid in one or more compensating chambers 36 is compressed, whereas, correspondingly, the volume of the other displacement chamber 33 increases. Upon relative rotation in the opposite rotational direction, the volume of the other displacement chamber 33 decreases, so that the first damper fluid displaced from it exerts a load on the second damper fluid in the assigned compensating chambers 36. It should be pointed out that, of course, the two displacement chamber assemblies 24, 46 can form the boundaries of a plurality of displacement chambers, possibly four, for example, following each other in a row around the circumference, two of which are always acting in parallel, that is, the volume of one of them increases while that of the other decreases.

To adjust the damping characteristic, i.e., the pressure relationships of the first damper fluid in the displacement chambers 32, the first damper fluid can be supplied to and/or removed from these chambers via channels 49, 50, visible in FIG. 1. For this purpose, furthermore, a rotary pass-through 52 is provided, the rotating part 54 of which is connected to the second displacement chamber assembly 46, whereas the nonrotating part 56 is connected to a source of pressurized fluid for first damper fluid and/or to a reservoir. Valve arrangements (not shown) can be used to increase or to decrease the fluid pressure of the first damper fluid in the various displacement chambers 32 and thus to adjust the damping characteristic, because it is possible in this way to vary the preload pressure which the first damper fluid exerts on the separating pistons 42, i.e., the pressure which acts on the second damper fluid in the compensating chambers 36, the pressure of which second fluid is usually held positive relative to the environment.

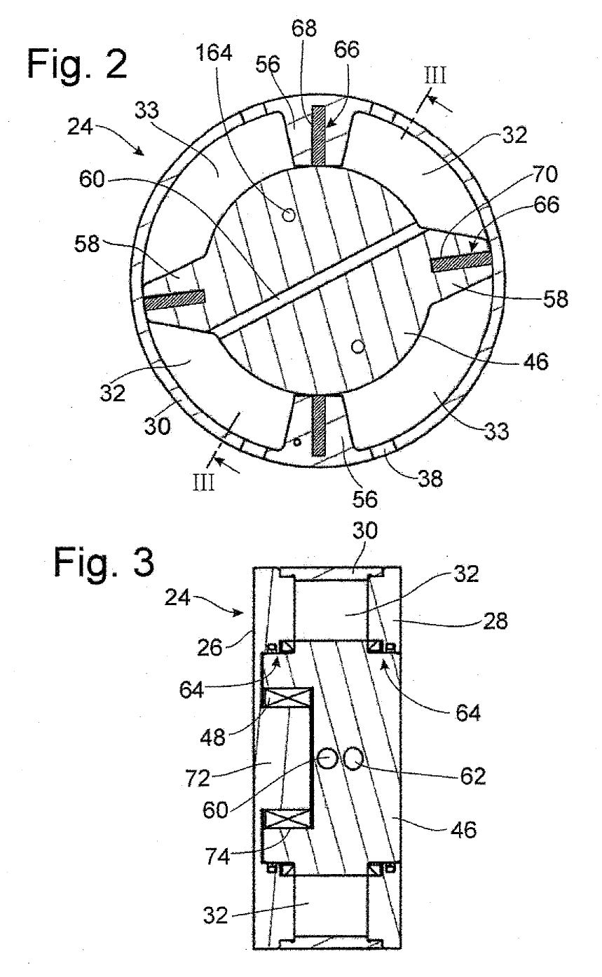

FIGS. 2 and 3 show in detail the design of the two displacement chamber assemblies 24, 46. We can see the two circumferential boundary projections 56 of the first displacement chamber assembly 24 on the circumferential wall 30 of the assembly; they are positioned opposite each other, that is, 1800 apart. In corresponding fashion, we can see the circumferential boundary projections 58 on the second displacement chamber assembly 46, designed as the central part. These projections extend radially outward toward the circumferential wall 30 and are also arranged 180° apart on the circumference. In this way, the two displacement chamber assemblies 24, 46 in fact form four displacement chambers 32, 32, 33, 33, arranged in a row around the circumference, which work together in pairs, and each of which is bounded in the circumferential direction by a pair of circumferential boundary projections 56, 58. The displacement chambers of each cooperating pair, i.e., chambers 32, 32 and chambers 33, 33, are connected to each other for exchange of fluid by connecting channels 60, 62 in the second displacement chamber assembly 46. Depending on the direction of relative rotation between the primary side 20 and the secondary side 44, the volume of the two displacement chambers 32 decreases, whereas the volume of the two displacement chambers 33 increases or vice versa.

To achieve a fluid-tight closure which reliably prevents the unwanted escape of first damper fluid in the areas where the two displacement chamber assemblies 24, 46 are in contact, first sealing arrangements 64 act between the end walls 26, 28 and the second displacement chamber assembly 46. As FIG. 3 already suggests, these first sealing arrangements are essentially identical in design and will be explained in greater detail further below. Second sealing arrangements 66 act between the circumferential boundary projections 58 and the other assembly in question and also between the circumferential boundary projections 56 and the end walls 26, 28. These second sealing arrangements 66, each of which is inserted into an assigned radially inward-facing or radially outward-facing recess 68, 70 in the circumferential boundary projections 56, 58, can also be essentially identical in design and will also be explained in greater detail below.

Once can also see in FIG. 3 the bearing 48, by which the two displacement chamber assemblies 24, 46 are supported with respect to each other. The bearing 48 acts between an axial extension 72 in the central area of the end wall 26, which fits into a corresponding recess 74 in the second displacement chamber assembly 46. The bearing 48 can be designed as a rolling element bearing preferably a needle bearing, which is especially advantageous because it is especially good at absorbing the loads which occur during the continually reversing rotational movements around comparatively small angles. It is also preferable for the bearing 48 to be designed as a so-called “loose” bearing, that is, a bearing which provides radial support for the two displacement chamber assemblies 24, 46 with respect to each other, but which does not lock them in place axially with respect to each other. This axial locking or defined axial positioning with respect to each other is accomplished essentially by the two first sealing arrangements 64, and this is done without any overdetermination which could cause jamming. For example, the inner race of a needle bearing can be placed on the extension 72, and the rolling elements of this needle bearing can then roll along an inner circumferential surface of the recess 74. The opposite arrangement could also be provided, according to which the race of the needle bearing is fitted into the recess 74. The surfaces which cooperate with the rolling elements during their rolling movements can hardened, for example, to protect them from excessive wear.

Alternatively, it is obviously also possible to insert a so-called “fixed” bearing, that is, a bearing which also holds the two connected assemblies axially in position with respect to each other. An overdetermination, i.e., the possibility of jamming, can be avoided in that, during assembly, one of the end walls or possibly even both end walls 26, 28 are held loosely with respect to the outside circumferential wall 30 and then connected permanently together only after they have been assembled with the outside wall. The use of shim rings or the like is also conceivable. It is to be emphasized in particular that the use of a plain bearing in place of a rolling element bearing is also possible.

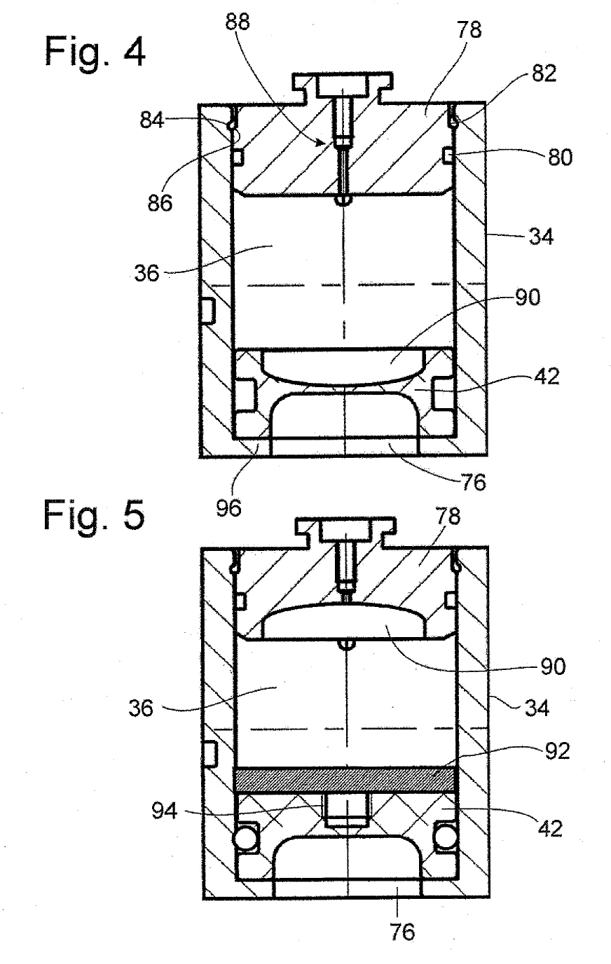

FIG. 4 shows in detail an embodiment of a compensating cylinder 34 with the compensating chamber 36 and the separating piston 42 inside it. Several of these compensating cylinders 34 in a star-like configuration, for example, can be provided in an assembly around the outside circumference of the first displacement chamber assembly 24.

In the area where the compensating cylinder 34 is designed to face radially inward and therefore in the area where it is adjacent to the displacement chamber 24, it has an opening 76, through which the first damper fluid displaced into the connecting chamber 40 can enter the cylinder 34 and thus exert a load on the rear surface of the separating piston 42 facing away from the compensating chamber 36. At the other end, that is, at the end which is designed to face radially outward, the compensating cylinder 34 is closed off by a closure element 78. This can carry, for example, a sealing element, which is inserted in an outside circumferential groove 80 and which establishes a fluid-tight seal against the compensating cylinder 34. The sealing element 78 can be held in place by means of a locking ring 82, which is inserted into an inside circumferential groove in the compensating cylinder 34. This ring can be inserted after the closure element 78 has been pushed far enough into the interior of the compensating cylinder 34 that it no longer overlaps the inside circumferential groove 84 in the compensating cylinder 34 designed to accept the locking ring 82. Then the closure element 78 can be pulled back outward (i.e., upward in FIG. 4), until a shoulder 86 provided on it comes to rest against the locking ring 82. The compensating chamber 36 can be filled through an opening/valve arrangement 88 in the closure element 78.

To ensure, even at maximum load on the compressible second damper fluid contained in the compensating chamber 36, that is, even when the separating piston 42 is not in its lowest possible position with maximum volume of the compensating chamber 36 but is instead, for example, in direct contact with the closure element 78 and thus is in its other end position, that the second damper fluid is not overcompressed, the separating piston 42 has a recess 90 in the side facing the compensating chamber 36. In this state, the second damper fluid can collect in this recess under comparatively high pressure. Further compression, however, is no longer possible, and because the second damper fluid cannot be overcompressed, overloads and overheating are avoided. This can in fact lead to a state in which the pressure in the first damper fluid is significantly above that in the second damper fluid.

In the case of the alternative embodiment shown in FIG. 5, the recess 90 is provided in the closure element 78. A layer 92 of elastomeric material, for example, is provided on the side of the separating piston 42 facing the compensating chamber 36 to ensure that the separating piston 42 is not braked abruptly to a stop by the closure element 78 but instead arrives in its end position with a soft landing.

It can also be seen in FIG. 5 that an internally threaded hole 94 is provided in the side of the separating piston 42 facing the closure element 78. After the closure element 78 and the layer 92 have been removed, a tool can be screwed into this hole to remove the separating piston 42.

It can also be seen in FIGS. 4 and 5 that a ring-like section 96 is provided on the compensating cylinder 34, surrounding the opening 76. This ensures that, when there is no load being exerted by the first damper fluid or when the pressure in the first damper fluid is lower than that of the second damper fluid, the separating piston 42 has a contact surface and cannot leave the compensating cylinder 34. This contact surface 96 can be an integral part of the compensating cylinder 34, but it could also be realized as a locking ring or the like, which is inserted into the cylinder.

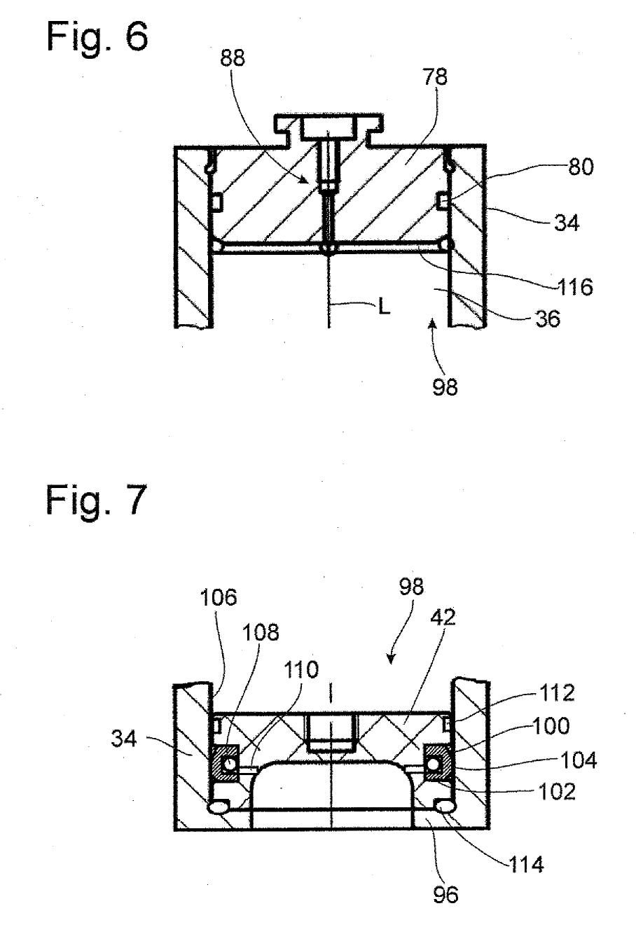

FIGS. 6 and 7 show partial aspects of a third sealing arrangement 98, by means of which the fluid-tight closure of the separating piston 42 versus the compensating chamber 36 and versus the displacement chambers 32, 33 is realized. As an essential component, this third sealing arrangement 98 comprises a ring-like sealing element 100, which is inserted into an outside circumferential groove 102 in the separating piston 42. This sealing element 100, designed, for example, as a plastic ring with good sliding properties, has a sealing surface area 104 which rests against the inside surface 106 of the compensating cylinder 34. So that this contact occurs under pressure, a prestressing element 108 designed as, for example, a rubber O-ring can produce a radially outward-directed force.

One can also see in FIG. 7 several openings or channels 110, leading to the rear surface of the separating piston 42, that is, to the side of the piston facing away from the compensating chamber 36; these channels are open to the bottom area of the circumferential groove 102. This circumferential groove 102 is therefore connected by these channels 110 to a pressure chamber which, at certain times, contains first damping fluid under high pressure. Via the channels 110, this pressure also acts on the rear surface of the sealing element 100 facing away from the inside circumferential surface 106 of the compensating cylinder 34 and therefore presses this sealing element even more strongly in the radially outward direction—radial with respect to the longitudinal center axis L of the compensating cylinder 34—to bring about an even further improvement in the sealing action.

A guide element designed as a plastic or metal ring can be provided in another circumferential groove 112 in the separating piston 42. Alternatively or additionally to the outside circumferential surface of the separating piston 42, this element can provide a guide function for the piston in the compensating cylinder.

An O-ring-like sealing element 114 is provided in the transition area between the annular contact surface 96 and the compensating cylinder 34. This sealing element 114 goes into effect when the separating piston 42 is in its lower end position, that is, for example, when the pressure of the second damper fluid in the compensating chamber 36 is higher than the pressure of the first damper fluid, which otherwise also exerts a force on the separating piston 42. Because, in this situation, the additional pressure supporting the sealing element 100 is lower or absent, the sealing element 114 provides an increased sealing action. It should be pointed out that the sealing element 114 could also be provided alternatively on the separating piston 42 and thus move along with it.

An O-ring-like sealing element 116 is also provided for the other end position of the separating piston 42. This element is located in the transition area between the compensating cylinder 34 and the closure element 78. If the separating piston 42 has been pushed into its upper end position by a correspondingly high pressure of the first damper fluid, the sealing element 116 provides a more effective seal against the escape of second damper fluid, which is now under very high pressure. This sealing element 116 can also be provided alternatively on the separating piston 42.

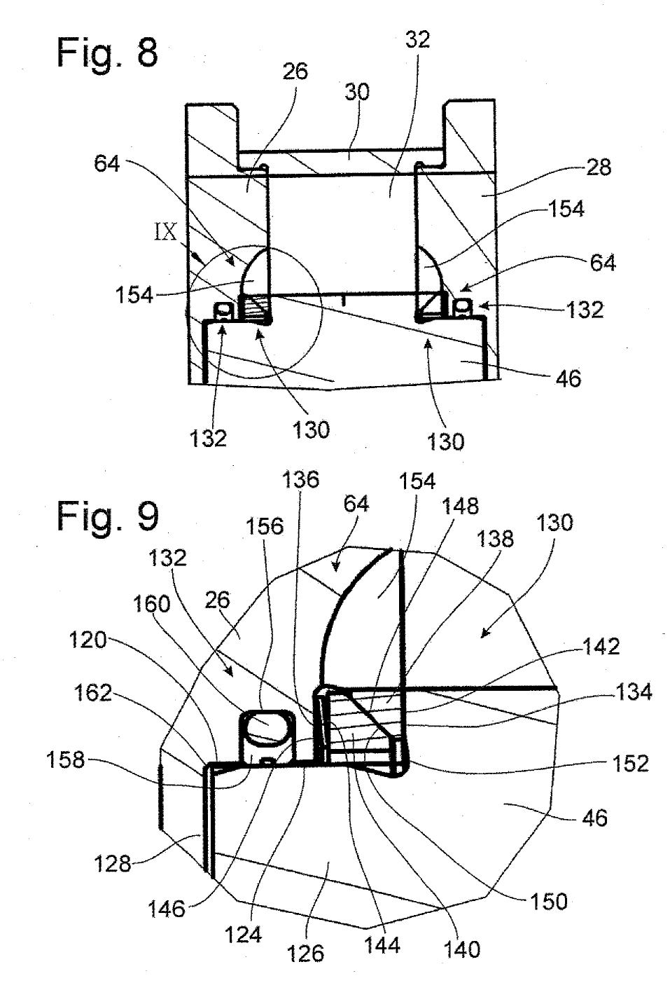

FIGS. 8 and 9 show in detail the design of the two first sealing arrangements 64 previously mentioned in conjunction with FIG. 3. These are basically identical and are therefore described in detail with reference to the enlarged diagram of FIG. 9 on the basis of the sealing arrangement 64 located on the left, that is, on the side facing away from the rotary pass-through 52.

It can be seen first that the end wall 26 provides an inside circumferential surface 120, which is essentially cylindrical and is located opposite a corresponding outside circumferential surface 124 of the second displacement chamber assembly 46. In the area of a section 126 including this outside circumferential surface 124, which section also forms the recess 74, the second displacement chamber assembly 46 therefore engages in an essentially ring-like recess 128 in the end wall 26. The first sealing arrangement 64 is designed with two stages with two sealing areas 130, 132. The first sealing area 130 acts between the lateral surface 134 of the second displacement chamber assembly 36 and the axially opposing surface 136 of the end wall 26. It can be seen that the lateral surface 134 of the second displacement chamber assembly 46 lies radially inside the circumferential boundary projection 58 provided on the assembly or extends radially outward as far as the radial area of that projection.

The first sealing area 130 includes two sealing rings 138, 140. The first sealing ring 138 has a first support surface 142, which rests against the lateral surface 134 of the second displacement chamber assembly 46, where these contacting surfaces are preferably perpendicular to the axis of rotation A. One side of a prestressing spring 146 is supported against the lateral surface 136 of the end wall 26, and the other side is supported against the first support surface 144 of the second sealing ring 140, thus subjecting it to a force acting toward the first sealing ring 138. The prestressing spring 146 can be designed as a disk spring, for example, or as a wave spring. The second support surfaces 148, 150 of the two sealing rings 138, 140 rest against each other, where these two support surfaces are essentially conical with respect to the axis of rotation A, so that the second sealing ring 140 is pressed by the prestressing spring 146 in wedge-like fashion into the first sealing ring 138 and thus also centers it and subjects it to an outward-directed force.

It is possible in principle that, upon relative rotation between the primary side and the secondary side, the first support surface 142 of the first sealing ring 138 can move with friction relative to the lateral surface 134. To prevent the second sealing ring from creating friction also, the second displacement chamber assembly 46 6an be designed with an axial indentation 152 radially inside its lateral surface 134, so that an offset extending toward the rear from the lateral surface 134, that is, in the direction away from the second sealing ring 140, is realized.

In an alternative design, it can be ensured through appropriate selection of the frictionally interacting components, that is, through appropriate selection of their materials, that the first sealing ring 138 rotates along with the second displacement chamber assembly 46 and that therefore the two second support surfaces 148, 150 slide along each other. This offers the advantage that it is possible to avoid undesirable interaction between the first sealing ring 138 and the second sealing arrangements 66, which are to be described further below. Otherwise the ring and the sealing arrangements would move relative to each other in the circumferential direction.

A notch-like indentation 154 can be formed in the end wall 26, namely, in the area of a circumferential boundary projection 56 or possibly in the area of both circumferential boundary projections 56. This notch can produce a fluid connection between at least one of the displacement chambers 32, 33 located on either side of the circumferential boundary projection 56 in question, which is formed on the circumferential wall 30, and the second support surface 144 of the second sealing ring 140. The high pressure of the first damper fluid can therefore exert force on the second sealing ring 140 in the area of its first support surface 144, which is only partially covered by the prestressing spring 146, and thus help to press the two sealing rings 138, 140 together more strongly.

The second sealing area 132 includes a sealing ring 158, which can be designed in the manner of a Roto Glyd Ring® and which is inserted into circumferential groove 156, which is open radially toward the inside. A prestressing element 160, possibly a rubber O-ring, mounted on the rear surface of the sealing ring, can exert force on the sealing ring 158 in the radially inward direction and thus onto the circumferential surface 124. To avoid damage to this sealing ring during the assembly of the two displacement chamber assemblies 24, 46, the section 126 can be designed with a conical feed bevel 162, so that sharp-edged contact with the sealing ring 158 is avoided.

In the case of the second sealing area 132 as well, advantage can be taken of the fluid pressure of the first damper fluid by providing, for example, a channel-like connection between the area where the first sealing area 130 is and the groove 156. The first damper fluid arriving in this area can exert force on the rear surface of the sealing ring 158 and thus press it down more strongly.

First damper fluid which manages to pass beyond the two sealing areas 130, 132 can be conducted to the rotary pass-through or to a sump for the first damper fluid by way of several leakage channels 164, which, as can be seen in FIG. 2, are provided in the second displacement chamber assembly 46.

It should be noted that, of course, each of the various sealing elements, i.e., in the present case the sealing rings 138, 140, and 158, can be made of the best possible materials, e.g., plastic materials, for the requirements they are intended to fulfill and thus provide the desired coefficient of friction for the friction partners in question.

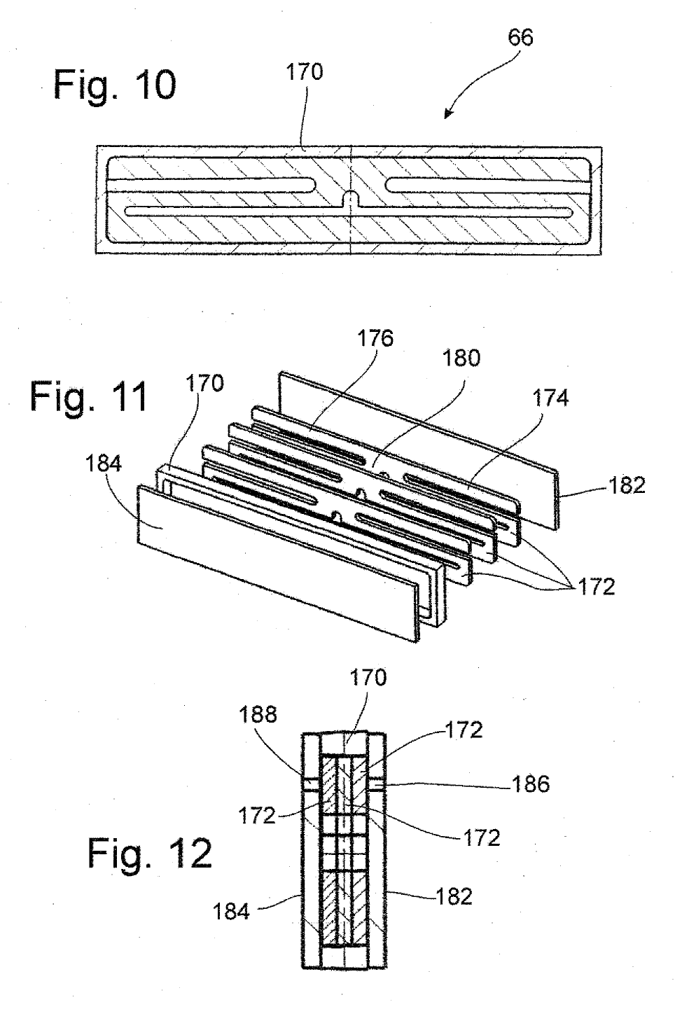

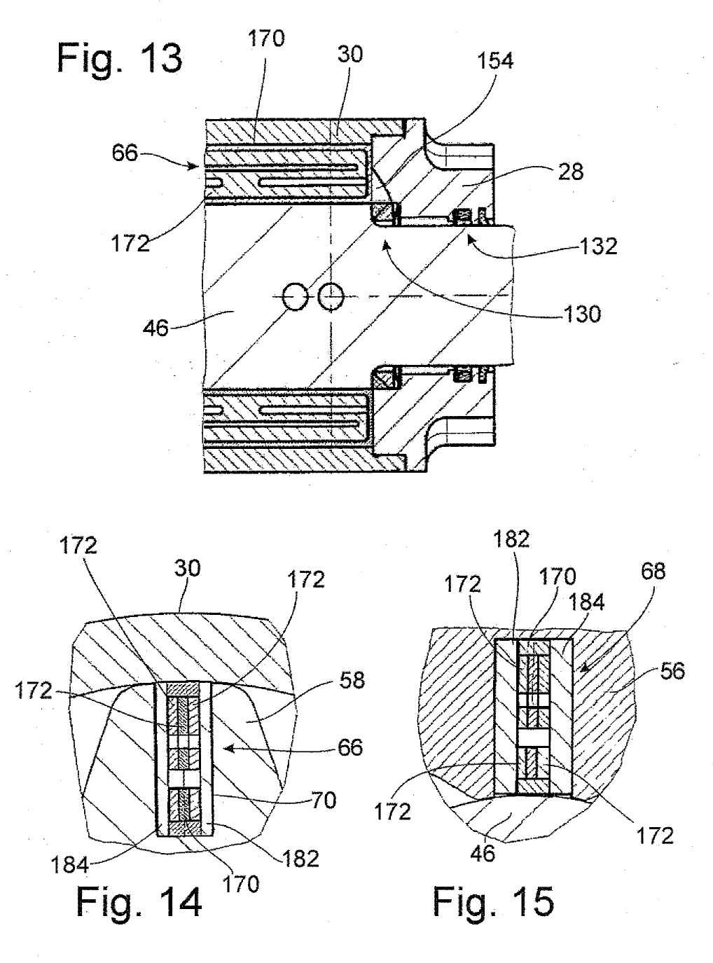

The structure of the second sealing arrangements 66 provided in the circumferential boundary projections 56, 58 is described below with reference to FIGS. 10-15. It should be noted that the second sealing arrangements 66 provided both in the circumferential boundary projections 56 of the first displacement chamber assembly 24 and in the circumferential boundary projections 58 of the second displacement chamber assembly 46 can be of identical design.

To hold this second sealing arrangement 66, each of the circumferential boundary projections 56 has a recess 68, which is open in the radially inward direction, whereas each of the circumferential boundary projections 58 has a recess 70, which is open in the radially outward direction. These recesses have already been explained above. They are open in both axial directions, so that they can produce a fluid-tight seal against the two end walls 26, 28 especially in the case of the circumferential boundary projections 56 of the first displacement chamber assembly 24, which do not move relative to the end walls 26, 28.

Each of these sealing arrangements 66 has an essentially rectangular frame as a sealing element 170, the dimensions of which are such that it projects slightly beyond the recesses 68, 70 in both the radial and axial directions. In the volume area surrounded by the frame-like sealing element 170, prestressing elements 172, made of sheet metal or plastic material, are arranged; in the example shown here, there are three of these prestressing elements, which can be essentially of identical design. These prestressing elements 172 have several beam sections 174, 176, 180, which are formed in such a way that, after they have been positioned in the frame-like sealing element 170, they spread it outward. Cover plates 182, 184 are provided on both sides of the frame-like sealing element 170. These close off the volume area surrounded by the frame-like sealing element 170, in which the three prestressing elements 172 are also situated, and thus provide support against the walls forming the boundaries of the recesses 68, 70. It can be seen in FIG. 12 that at least one opening 186, 188 is formed in each of these cover plates 182, 184. The interior volume area is connected by these openings to the displacement chambers 32, 33 located on either side of the associated circumferential boundary projection 56 or 58, namely, by way of the gap-like intermediate spaces also formed in the area of the recesses 68, 70 with respect to the cover plates 182, 184. Thus the pressure of the first damper fluid can also act in the interior volume area of the frame-like sealing element 170 and load it in the outward direction, so that it is pressed both axially and radially out of the associated recess 68, 70 and thus into contact with the end walls 26, 28 and, in the radial direction, against the other displacement chamber assembly.

The positioning of the second sealing arrangements 66 in the radial direction is selected so that they are as close as possible to the outside circumference of the first sealing arrangements 64, so that, if possible, no intermediate spaces at all are created, through which the pressure could equalize between the various displacement chambers. So that the best possible fit can be achieved here, one can proceed in such a way that, first, the second sealing arrangements and also the other components are inserted into the various displacement chamber assemblies. The assemblies are then put together, and the shapes of the various sealing arrangements are deformed so as to form-fit them in their locations.

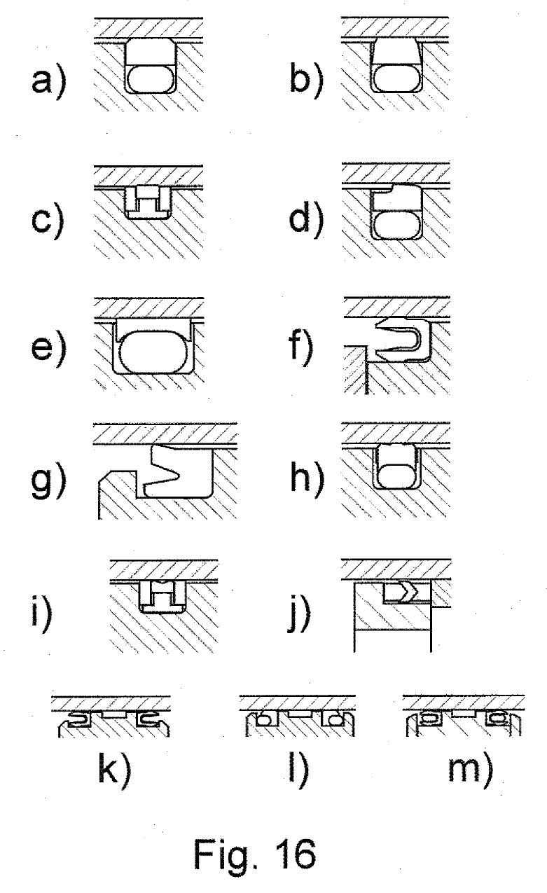

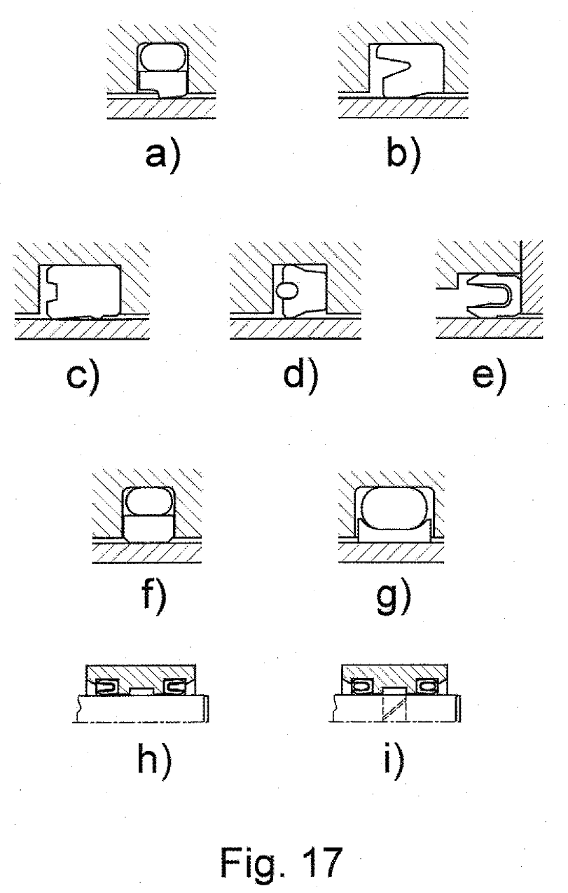

FIGS. 16 and 17 show a wide variety of configurations of sealing formations formed either as so-called “piston seals” (FIG. 16) or as so-called “rod seals” (FIG. 17). Each sealing formation has a sealing ring, which is mounted in a groove or recess, and which is prestressed into its sealing position by assigned prestressing elements or, alternatively or additionally, by fluid pressure. It should be explained in reference to these diagrams that all of these sealing formations can be provided especially in the area of the separating piston 42, that is, as component areas of the third sealing arrangements 98, and also in the area of the first sealing arrangements, namely, especially in the area of the second sealing area 132.

In the discussion above concerning the first sealing arrangements 68, especially their second sealing areas 132, and also concerning the third sealing arrangements 98, sealing elements with a closed, ring-like structure have been described in each case. Open ring-like sealing elements can also be used in these sealing arrangements, especially in the second sealing areas 132 of the first sealing arrangements 64, that is, sealing elements which are interrupted at a certain point in their circumference, and which therefore, as a result of the elasticity of their material, can be flexible in the radial direction. These types of sealing elements are usually made of plastic material and have lock formations at the ends of the ring lying adjacent to each other in the circumferential direction. These lock formations make it possible to obtain a tight seal even though the ring is open. These types of open sealing elements can be installed with radial prestress in their assigned grooves, that is, in the case of the second sealing areas 132, for example, which can be seen in FIGS. 8 and 9, they can be prestressed in the radially outward or advantageously in the radially inward direction, so that, especially with respect to the outside circumferential surface 124 of the associated section 126, an essentially fluid-tight contact seal is produced. The fluid pressure acting on one side of one of these sealing elements, i.e., from the right in FIG. 9, presses the sealing element against a lateral wall of the groove and thus again produces a fluid-tight closure with respect to the end wall 26 carrying this groove. These sealing elements designed with an open, ring-like structure can be designed with a wide variety of cross-sectional shapes; they can have, for example, a triangular cross section, a rectangular cross section, a polygonal cross section, or even a round cross section.

In conclusion, it should be noted that the various aspects described above can be combined with each other in any desired way. For example, all of the sealing arrangements can be designed as explained above. Of course, it is also possible to design only the first sealing arrangements as described, for example, whereas different designs are selected for the second and third sealing arrangements. The same also obviously applies to the design of the compensating cylinders, as explained in detail on the basis of FIGS. 4 and 5, and the bearing, by which the two displacement chamber assemblies are supported rotatably with respect to each other

The invention is not limited by the embodiments described above which are presented as examples only but can be modified in various ways within the scope of protection defined by the appended patent claims.

We claim:

1. A torsional vibration damper comprising:
a primary side;
a secondary side which can rotate around an axis of rotation relative to the primary side;
a damping fluid arrangement comprising at least one displacement chamber containing a first damper fluid and at least one compensating chamber containing a second damper fluid, wherein the second damper fluid is more compressible than the first damper fluid, wherein rotation of the primary side relative to the secondary side causes displacement of the first damper fluid from at least one said displacement chamber and compression of the second damper fluid in at least one said compensating chamber;
a first displacement chamber assembly comprising a pair of axially opposed end walls bounding said at least one displacement chamber in both axial directions and a circumferential wall bounding said at least one displacement chamber in one radial direction;
a second displacement chamber assembly bounding said at least one displacement chamber in the other radial direction; and
first sealing arrangements acting between said axially opposed end walls and said second displacement chamber assembly to produce an essentially fluid-tight closure of said at least one displacement chamber.

2. The torsional vibration damper of claim 1 wherein each said axial end wall comprises an axial surface and a circumferential surface, and the second displacement chamber assembly comprises at least one axial surface and at least one circumferential surface, at least one said first sealing arrangement comprising a first sealing area which seals the axial surface of the end wall against the axial surface of the second displacement chamber assembly, and a second sealing area which seals the circumferential surface of the end wall against the circumferential surface of the second displacement chamber assembly.

3. The torsional vibration damper of claim 2 wherein the first sealing area comprises a first sealing ring having a support surface supported against the axial surface of the second displacement chamber assembly, and a second sealing ring having a support surface supported against the axial surface of the end wall by a prestressing element, said first and second sealing rings having respective sealing surfaces which rest against each other.

4. The torsional vibration damper of claim 3 wherein at least one of said support surfaces is perpendicular to the axis of rotation.

5. The torsional vibration damper of claim 3 wherein the sealing surfaces are essentially conical with respect to the axis of rotation.

6. The torsional vibration damper of claim 3 wherein the second sealing ring does not contact the second displacement chamber assembly.

7. The torsional vibration damper of claim 3 wherein the prestressing element is one of a wave spring and a disk spring.

8. The torsional vibration damper of claim 3 further comprising a connecting recess formed in at least one of said end walls, said connecting recess forming a fluid connection between at least one said fluid displacement chamber and a side of the second sealing element facing away from the second fluid displacement chamber assembly.

9. The torsional vibration damper of claim 2 wherein the second sealing area comprises a groove in the circumferential surface of one of said end wall and said second displacement chamber assembly, and a sealing ring in the groove, the sealing ring having a sealing surface resting against the circumferential surface of the other of said end wall and said second displacement chamber assembly.

10. The torsional vibration damper of claim 9 further comprising a prestressing arrangement loading the sealing ring against the circumferential surface of the other of said end wall and said second displacement chamber assembly.

11. The torsional vibration damper of claim 10 wherein the prestressing arrangement comprises at least one resilient prestressing element.

12. The torsional vibration damper of claim 10 wherein the prestressing arrangement comprises a pressurized fluid connection connecting the groove to at least one said displacement chamber.

13. The torsional vibration damper of claim 9 wherein the sealing ring is an open ring having a circumference with an interruption.

14. The torsional vibration damper of claim 2 wherein said first sealing arrangements are substantially identical.

15. A torsional vibration damper comprising:
a primary side;
a secondary side which can rotate around an axis of rotation relative to the primary side;
a damping fluid arrangement comprising at least one displacement chamber containing a first damper fluid and at least one compensating chamber containing a second damper fluid, wherein the second damper fluid is more compressible than the first damper fluid, wherein rotation of the primary side relative to the secondary side causes displacement of the first damper fluid from at least one said displacement chamber and compression of the second damper fluid in at least one said compensating chamber,
a first displacement chamber assembly comprising a pair of axially opposed end walls bounding said at least one displacement chamber in both axial directions and a circumferential wall bounding said at least one displacement chamber in one radial direction;
a second displacement chamber assembly bounding said at least one displacement chamber in the other radial direction;
a first circumferential boundary projection provided on the first displacement chamber assembly and extending radially toward the second displacement chamber assembly, and a second circumferential boundary projection provided on the second displacement chamber assembly and extending radially toward the first displacement chamber assembly, said first and second circumferential boundary projections bounding said at least one displacement chamber in opposite circumferential directions; and
second sealing arrangements provided on respective said first and second circumferential boundary projections to produce an essentially fluid-tight closure of said at least one displacement chamber.

16. The torsional vibration damper of claim 15 wherein at least one said second sealing arrangement comprises a radially and axially open recess in the circumferential boundary projection, and a radially and axially prestressed sealing element inserted into the recess.

17. The torsional vibration damper of claim 16 wherein each said sealing element comprises a sealing frame and at least one prestressing element which prestresses the frame in at least one of axial and radial directions.

18. The torsional vibration damper of claim 17 wherein each said sealing element further comprises a pair of cover elements which seal off the frame on both sides.

19. The torsional vibration damper of claim 18 wherein at least one of said cover elements has a fluid inlet.

20. A torsional vibration damper comprising:
a primary side;
a secondary side which can rotate around an axis of rotation relative to the primary side;
a damping fluid arrangement comprising at least one displacement chamber containing a first damper fluid and at least one compensating chamber containing a second damper fluid, wherein the second damper fluid is more compressible than the first damper fluid, wherein rotation of the primary side relative to the secondary side causes displacement of the first damper fluid from at least one said displacement chamber and compression of the second damper fluid in at least one said compensating chamber,
a first displacement chamber assembly comprising a pair of axially opposed end walls bounding said at least one displacement chamber in both axial directions and a circumferential wall bounding said at least one displacement chamber in one radial direction;
a second displacement chamber assembly bounding said at least one displacement chamber in the other radial direction;
at least one compensating cylinder in which a respective at least one said compensating chamber is formed, and at least one separating piston in each said cylinder separating the first damper fluid from the second damper fluid; and
a third sealing arrangement acting between each said piston and said cylinder to produce an essentially fluid-tight closure of the at least one compensating chamber.

21. The torsional vibration damper of claim 21 wherein the third sealing arrangement comprises:
a circumferential recess in each said sealing piston;
a sealing ring inserted in each said circumferential recess;
a prestressing element inserted in each said recess loading said sealing ring radially against said cylinder.

22. The torsional vibration damper of claim 21 further comprising at least one connecting opening connecting the circumferential recess to a pressure chamber.

23. The torsional vibration damper of claim 21, wherein the sealing ring is an open ring having a circumference with an interruption.

24. The torsional vibration damper of claim 20 wherein the separating piston is movable between opposite end positions, the third sealing arrangement further comprising an end seal on the compensating cylinder, the end seal being arranged to produce a seal between the separating piston and the cylinder in one of the end positions.

25. The torsional vibration damper of claim 20 further comprising a closure element closing at least one said compensating chamber oppositely from the separating piston, the damper further comprising a holding recess facing said compensating chamber in at least one of said separating piston and said closure element.

26. The torsional vibration damper arrangement of claim 20 further comprising a bearing arrangement supporting the first displacement chamber assembly for rotation with respect to the second displacement chamber assembly.

27. The vibration damper arrangement of claim 26 wherein the bearing arrangement is designed to permit relative axial movement between the first and second displacement chamber assemblies.
